(19) United States
(12) Patent Application Publication
(10) Pub. No.: US 2008/0176137 A1
(43) Pub. Date: Jul. 24, 2008

(54) ENERGY STORAGE DEVICE

(75) Inventors: Koji ENDO, Hirakata-city (JP); Hiroshi NONOUE, Hirakata-city (JP)

Correspondence Address: DITTHAVONG MORI & STEINER, P.C., 918 Prince St., Alexandria, VA, 22314, US

(73) Assignee: Sanyo Electric Co., Ltd., Moriguchi-city (JP)

(21) Appl. No.: 12/015,594

(22) Filed: Jan. 17, 2008

(30) Foreign Application Priority Data
Jan. 18, 2007 (JP) 2007-009185

(51) Int. Cl. H01M 4/02

(52) U.S. Cl. 429/209

(57) ABSTRACT

An energy storage device comprising a positive electrode composed of a polarizable electrode including activated carbon, a negative electrode using a material capable of inserting and extracting lithium ions as an anode active material, and a nonaqueous electrolyte, wherein lithium-containing porous metal oxide is included as the anode active material contained in the negative electrode, and as the lithium-containing porous metal oxide, for example, porous LiₓSiO is used, and a mixture of the lithium-containing porous metal oxide and a carbon material capable of inserting and extracting lithium ions is preferably used.

### BACKGROUND OF THE INVENTION

1. Field of the Invention

The present invention relates to an energy storage device which is a hybrid capacitor having both characteristics of an electric double layer capacitor and characteristics of a lithium ion secondary battery.

2. Description of the Related Art

In recent years, energy storage devices, which comprise a positive electrode composed of a polarizable electrode using activated carbon, a negative electrode using, as an anode active material, a material formed by making a carbon material capable of inserting and extracting lithium ions insert lithium ions and an organic electrolyte including lithium salt as a solute, attract attention (for example, Japanese Patent Laid-Open No. H11-54383).

This energy storage device has such performance that characteristics of a lithium ion secondary battery and characteristics of an electric double layer capacitor are combined, and is characterized by having a high energy density compared with the electric double layer capacitor while having a high power density and a good cycle characteristic as with the electric double layer capacitor.

This energy storage device is suitable for a high power application that a lithium ion secondary battery is not suitable for, and is expected to be applied to a power source of a hybrid car.

In the Japanese Patent Laid-Open No. H11-54383, carbon materials such as natural graphite, artificial graphite, non-graphitizable carbon, graphitizable carbon and low temperature burning carbon are included as an anode material. These carbon materials have a very small specific surface area in comparison with activated carbon used in a positive electrode. Therefore, the electrolyte quantity to be stored in the negative electrode is considered to be less than that in the positive electrode based on activated carbon. Therefore, there is a problem that a balance between electrolyte ions in the positive electrode and the negative electrode is disrupted, and a shortage of ion occurs in outputting a high-power that this device is good with, and a rate characteristic is deteriorated. Further, in a cycle life, if the electrolyte quantity to be stored in an electrode is small, there is a high possibility of exhausting the electrolyte ions, and this causes the deterioration of capacity through repeating charge-discharge over a long period of time.

Further, when a polarizable electrode based on activated carbon is used as the positive electrode, a carbon material in which lithium is previously inserted (Japanese Patent Laid-Open No. H11-54383), or a lithium alloy (Japanese Patent Laid-Open No S60-167280) is used as an anode active material. These materials are used because a voltage range utilizable with this energy storage device can be enlarged by containing lithium in advance.

However, there is a problem that load characteristics is also deteriorated because of a shortage of electrolyte quantity to be stored in an electrode when such an anode active material is used.

### SUMMARY OF THE INVENTION

It is an object of the present invention to provide an energy storage device comprising a positive electrode composed of a polarizable electrode including activated carbon, and a negative electrode including a material capable of inserting and extracting lithium ions as an anode active material, which has excellent load characteristics.

The present invention pertains to an energy storage device comprising a positive electrode composed of a polarizable electrode including activated carbon, a negative electrode including a material capable of inserting and extracting lithium ions as an anode active material, and a nonaqueous electrolyte, wherein lithium-containing porous metal oxide is included as the anode active material.

In the present invention, by including lithium-containing porous metal oxide as an anode active material, an adequate electrolyte can be stored in the negative electrode, and load characteristics can be improved without having a shortage of ion quantity in outputting a high-power.

Preferably, a BET specific surface area of the lithium-containing porous metal oxide is 50 m²/g or more. By having the BET specific surface area of 50 m²/g or more, a more adequate electrolyte can be stored in the negative electrode, and load characteristics can be further improved. An upper limit of the BET specific surface area is not particularly limited, but when the BET specific surface area exceeds 1000 m²/g, it is sometimes undesirable since a Li storage capacity per unit volume of the electrode is reduced to decrease a capacity or electrode strength is lowered to cause the deterioration during charge and discharge. Therefore, preferably, the BET specific surface area of the lithium-containing porous metal oxide in the present invention falls within a range of 50 to 1000 m²/g.

As the lithium-containing porous metal oxide in the present invention, for example, silicon (Si) oxide containing lithium is preferably used. Examples of oxides other than Si oxide include lithium-containing metal oxides based on metal oxides including an oxide of Sn, Fe, Ni, V, Co, Cd, Zn, Mn, Nb, Ti, W, Mo or Na, and two or more kinds thereof. B or P may be added to these metal oxides. Specific examples of the lithium-containing metal oxides include Li₃SnB_{0.5}P_{0.5}O₃, Li₅Fe₂O₃, Li₂₁VO₄, Li_{1.5}CoVO₄, Li_{1.5}CdVO₄, Li_{2.5}ZnVO₄, Li₂MnV₂O_{6.96}, Nb₂O₅, Li_{3/4}Ti_{5/3}O₄, Li_{0.1}WO₂, MoO₂, and Li_{3.4}Na₂O.1.5Fe₂O₃ (composition of each oxide is expressed by composition under discharge conditions).

In the present invention, it is preferred to use a mixture of the above-mentioned lithium-containing porous metal oxide and a carbon material capable of inserting and extracting lithium ions as an anode active material. The carbon material to be mixed is not particularly limited as long as it can insert and extract lithium, and examples of the carbon material include natural graphite, artificial graphite, non-graphitizable carbon, graphitizable carbon, and low temperature burning carbon. Among these, low crystalline graphitizable carbon burned at a temperature of 2000° C. or lower, and non-graphitizable carbon are particularly preferably used. These carbon materials can be identified through an interlayer distance between graphene sheets or a true specific gravity.

The interlayer distance between graphene sheets is lattice spacing determined from a peak of a (002) plane measured by powder X-ray diffractometry.

The highly crystalline graphite described below is highly crystalline graphite in which the interlayer distance between graphene sheets exhibits a value close to 3.354 Å which is the interlayer distance of natural graphite, and here, graphite having an interlayer distance of 3.30 to 3.40 Å and a true specific gravity of 2.1 g/cm³ or more is considered as highly crystalline graphite.

The interlayer distance of the non-graphitizable carbon does not come close to that of graphite and a large number of fine pores are present in the material of the non-graphitizable carbon even when the non-graphitizable carbon is burned at a high temperature of about 3000° C. Specifically, this is considered as a carbon material having an interlayer distance of 3.40 Å or more and a true specific gravity of 1.3 to 1.7 g/cm³.

The graphitizable carbon is increasingly graphitized little by little when a burning temperature exceeds 1000° C., and the interlayer distance and the true specific gravity thereof come close to those of graphite if the burning temperature exceeds 2500° C. The low crystalline graphitizable carbon is produced by burning the graphitizable carbon at a temperature of 1000 to 2000° C., and specifically it is a carbon material having an interlayer distance of 3.40 Å or more and a true specific gravity of 1.7 to 2.1 g/cm³.

FIG. 2 is a view showing an example of a potential behavior during charge and discharge of highly crystalline graphite. As shown in FIG. 2, the highly crystalline graphite drops the potential rapidly to around 0.2 V after beginning the insertion of Li and inserts Li while reducing the potential in a staircase pattern to around 350 mAh/g.

FIG. 3 is a view showing an example of a potential behavior during discharge of LiₓSiO (x=2.0 to 4.0). As shown in FIG. 3, LiₓSiO begins to discharge from a potential of 0.1 V (x=4.0), and extracts Li to discharge with the potential changed linearly until the potential of around 0.5 V (x=2.0).

Therefore, when LiₓSiO is mixed with the highly crystalline graphite, it extracts lithium (Li) until a potential of LiₓSiO is identical to that of the highly crystalline graphite (Li is inserted by the highly crystalline graphite). That is, when the potential of LiₓSiO is 0.5 V (x is 2.0 or less) before mixing LiₓSiO, the highly crystalline graphite inserts lithium of about 20 mAh/g, and when the potential of LiₓSiO is 0.1 V (x is 4.0) before mixing LiₓSiO, the highly crystalline graphite inserts lithium of about 100 mAh/g. Since the potential of the highly crystalline graphite drops rapidly from 0.5 V to around 0.2 V, an amount of inserted Li of the highly crystalline graphite is small. Accurately, x has to be more than 2 since there is no Li to be extracted at the time of x=2.0.

FIG. 4 is a view showing an example of a potential behavior during charge and discharge of low crystalline graphitizable carbon. When the low crystalline graphitizable carbon is mixed with LiₓSiO, it extracts lithium (Li) until a potential of LiₓSiO is identical to that of the low crystalline graphitizable carbon (Li is inserted by the low crystalline graphitizable carbon). That is, when the potential of LiₓSiO is 0.5 V (x is 2.0 or less) before mixing LiₓSiO, the low crystalline graphitizable carbon inserts lithium of about 50 mAh/g, and when the potential of LiₓSiO is 0.1V (x is 4.0) before mixing LiₓSiO, the low crystalline graphitizable carbon inserts lithium of about 150 mAh/g. Since the low crystalline graphitizable carbon exhibits a relatively mild change in a potential compared with the highly crystalline graphite, it can insert more Li in a wide range of the potential of LiₓSiO.

Also in a potential behavior during charge and discharge of the non-graphitizable carbon, an effect similar to that in the low crystalline graphitizable carbon can be attained since the non-graphitizable carbon exhibits a relatively mild change in a potential compared with the highly crystalline graphite.

Since the carbon material has higher stability than LiₓSiO which is a lithium-containing porous metal oxide, cycle characteristics of the mixture material are more improved as an amount of inserted lithium of the lithium-containing porous metal oxide becomes larger.

It is predicted from FIGS. 2 to 4 that more stable charge and discharge characteristics can be attained in mixing LiₓSiO with the low crystalline graphitizable carbon than in mixing LiₓSiO with the highly crystalline graphite.

By using a mixture of the above-mentioned lithium-containing porous metal oxide of the present invention and the above-mentioned carbon material, an energy storage device which is superior in load characteristics and cycle characteristics can be formed.

In the present invention, when the mixture of the lithium-containing porous metal oxide and the carbon material is used as an anode active material, preferably, a mixing ratio thereof (lithium-containing porous metal oxide:carbon material) is within a range of 10:90 to 90:10 by weight, more preferably, within a range of 25:75 to 75:25 by weight. By keeping the mixing ratio within such a range, an energy storage device which is further superior in both cycle characteristics and load characteristics can be formed.

The negative electrode in the present invention can be produced by a conventionally generally known method. The negative electrode may be prepared, for example, by mixing the above-mentioned lithium porous metal oxide, a binder, and a conductive agent to be used as required, adding the resulting mixture to a solvent to prepare a slurry, and applying this slurry onto metal foil such as copper foil and drying the slurry. Further, the negative electrode may be formed by press molding, and the like.

The positive electrode in the present invention is constructed from a polarizable electrode including activated carbon. The polarizable electrode including activated carbon can be used without particular restrictions as long as it can be used as a polarizable electrode such as an electric double layer capacitor and a hybrid capacitor. The positive electrode can be prepared, for example, by mixing activated carbon, a binder, and a conductive agent such as carbon black to be used as required, adding the resulting mixture to a solvent to prepare a slurry, and applying this slurry onto a collector made of metal foil such as aluminum foil and drying the slurry. Further, the positive electrode may be formed by press molding, and the like. As the activated carbon, substances formed by steam activation or KOH activation of coconut husks, phenolic resin, or petroleum cokes can be employed.

The nonaqueous electrolyte in the present invention is not particularly limited as long as it is a nonaqueous electrolyte which can be used for an electric double layer capacitor or a hybrid capacitor, and examples of lithium salt used as an solute include LiPF₆, LiBF₄, LiClO₄, LiN(CF₃SO₂)₂, CF₃SO₃Li, LiC(SO₂CF₃)₃, LiAsF₆ and LiSbF₆. Examples of the solvent include one kind or more selected from ethylene carbonate, propylene carbonate, butylene carbonate, dimethyl carbonate, ethyl methyl carbonate, diethyl carbonate, sulfolane and dimethoxyethane.

The concentration of lithium salt used as a solute is not particularly limited and is generally, for example, about 0.1 to 2.5 mol/liter.

In accordance with the present invention, an energy storage device having excellent load characteristics can be formed.

And, by employing the mixture of the lithium-containing porous metal oxide and the carbon material capable of inserting and extracting lithium ions as an anode active material, an energy storage device having an excellent load characteristics and excellent cycle characteristics can be formed.

### BRIEF DESCRIPTION OF THE DRAWINGS

FIG. 1 is a schematic sectional view showing a cell of an energy storage device prepared in Example according to the present invention,

FIG. 2 is a view showing an example of a potential behavior during charge and discharge of highly crystalline graphite,

FIG. 3 is a view showing an example of a potential behavior during discharge of LiₓSiO, and

FIG. 4 is a view showing an example of a potential behavior during charge and discharge of low crystalline graphitizable carbon.

### DETAILED DESCRIPTION OF THE PREFERRED EMBODIMENTS

Hereinafter, the present invention will be described by way of specific examples, but the present invention is not limited to the following Examples, and variations may be appropriately made without changing the gist of the present invention.

### [Preparation of Porous LiₓSiO]

### (Preparation of Porous SiO)

Mesoporous silica having a BET specific surface area of 1000 m²/g and silicon powder ground and regulated in a particle diameter to be 20 μm or less are mixed so as to have the same number of moles, and the resulting mixture was stirred and burned at a high temperature of 1000° C. or higher in argon gas to prepare porous SiO. This porous SiO was ground in an automatic mortar and regulated in a particle diameter to be 20 μm or less

### [Containing Lithium]

Li (Lithium) was included in the obtained porous SiO as described in the following.

First, a cell including porous SiO as a working electrode and lithium metal as an opposite electrode was produced. In the working electrode, the porous SiO as an active material, acetylene black as a conductive agent, and polyvinylidene fluoride as a binder were mixed so as to become a ratio of 80:10:10 by weight to prepare a combined material. This combined material was formed by press molding so as to be 20 mm in diameter and 0.5 mm in thickness. This molded article was attached to a stainless mesh by pressure, and a tab was attached to this stainless mesh to form a working electrode.

As an opposite electrode, an electrode, which was formed by attaching lithium foil having the same area as the working electrode and a thickness of 500 μm to a stainless mesh by pressure, and attaching a tab to this stainless mesh, was used.

A polyolefin micro-porous membrane was interposed between the working electrode and the opposite electrode, and impregnated with an electrolyte, and sealed with a laminate cell. As the electrolyte, a solution, which is formed by dissolving lithium hexafluorophosphate LiPF₆ so as to be 1 mol/liter in a mixture solvent composed of ethylene carbonate and diethyl carbonate in a proportion of 3:7 by volume, was used.

The produced cell was charged with a constant current of 0.05 mA to insert lithium into the porous SiO. Charged ampere-hour was selected in such a way that x becomes 2, 2.1, 2.5, 3 and 4 in LiₓSiO to prepare 5 kinds of LiₓSiO.

The cell after charged was disassembled, and the working electrode was taken out and cleaned with acetonitrile. Thereafter, a combined material layer was isolated from the stainless mesh and subjected to a heat treatment at 500° C. in vacuum to obtain LiₓSiO which is lithium-containing porous metal oxide. BET specific surface-areas of the obtained porous LiₓSiO were all 400 m²/g.

### [Preparation of Comparative Li₃SiO]

Li₃SiO to be used in Comparative Examples was as described in the following.

Commercially available SiO powder was ground in an automatic mortar and regulated in a particle diameter to be 20 μm or less, and Li (lithium) was included in the ground SiO powder by following the same procedure as in the above description to prepare Li₃SiO. A BET specific surface area of this comparative Li₃SiO was 8 m²/g.

### [Production of Energy Storage Device]

### (Production of Positive Electrode)

Activated carbon having a specific surface area of about 1500 m²/g was used as a cathode active material. This activated carbon powder, acetylene black as a conductive agent, and polyvinylidene fluoride as a binder were mixed so as to become a ratio of 80:10:10 by weight, and the resulting mixture was added to N-methylpyrrolidone as a solvent and stirred to prepare a slurry. This slurry was applied onto aluminum foil with 20 μm thickness by a doctor blade method and temporarily dried. Thereafter, the aluminum foil coated with the slurry was cut off in such a way that an electrode size is 20 mm×20 mm. The cut off aluminum foil was dried at 120° C. for 10 hours in vacuum before assembling a cell.

### (Production of Negative Electrode)

An anode active material, acetylene black as a conductive agent, and polyvinylidene fluoride as a binder were mixed so as to become a ratio of 80:10:10 by weight, and the resulting mixture was stirred in N-methylpyrrolidone as a solvent to prepare a slurry. This slurry was applied onto copper foil with 10 μm thickness by a doctor blade method and temporarily dried. Thereafter, the copper foil coated with the slurry was cut off in such a way that an electrode size is 20 mm×20 mm. The cut off copper foil was dried at 120° C. for 10 hours in vacuum before assembling a cell.

### (Preparation of Electrolyte)

Lithium hexafluorophosphate LiPF₆ was dissolved so as to be 1 mol/liter in a mixture solvent composed of ethylene carbonate and diethyl carbonate in a proportion of 3:7 by volume to prepare an electrolyte.

### (Assembling of Cell)

Using the above-mentioned positive electrode, the above-mentioned negative electrode, and the above-mentioned electrolyte, a cell, which is an energy storage device, was produced in a manner described below.

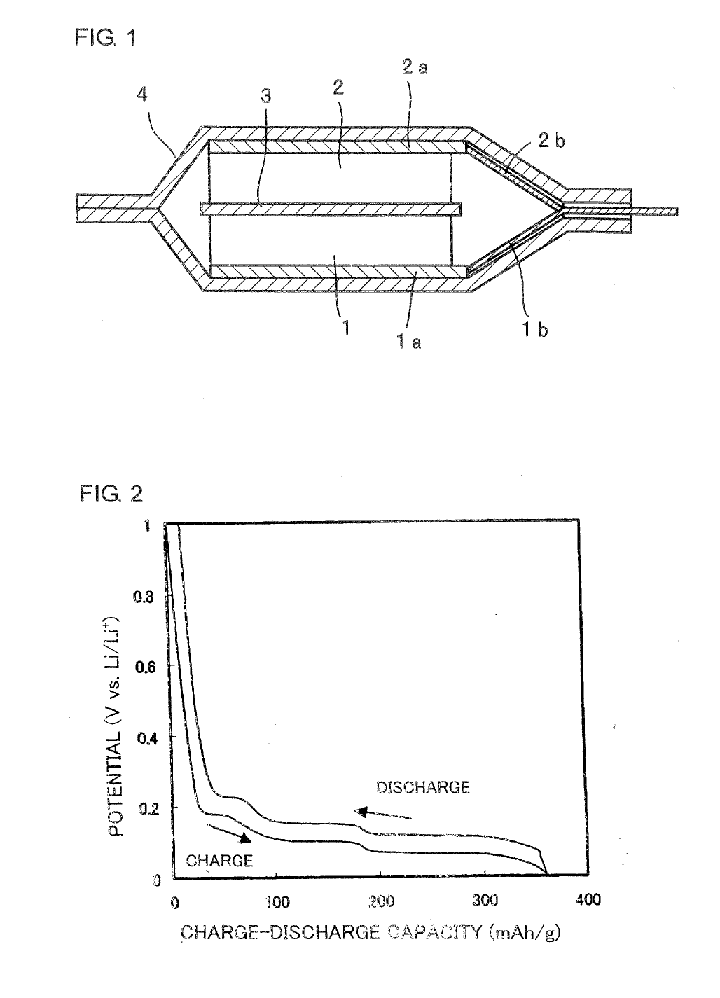

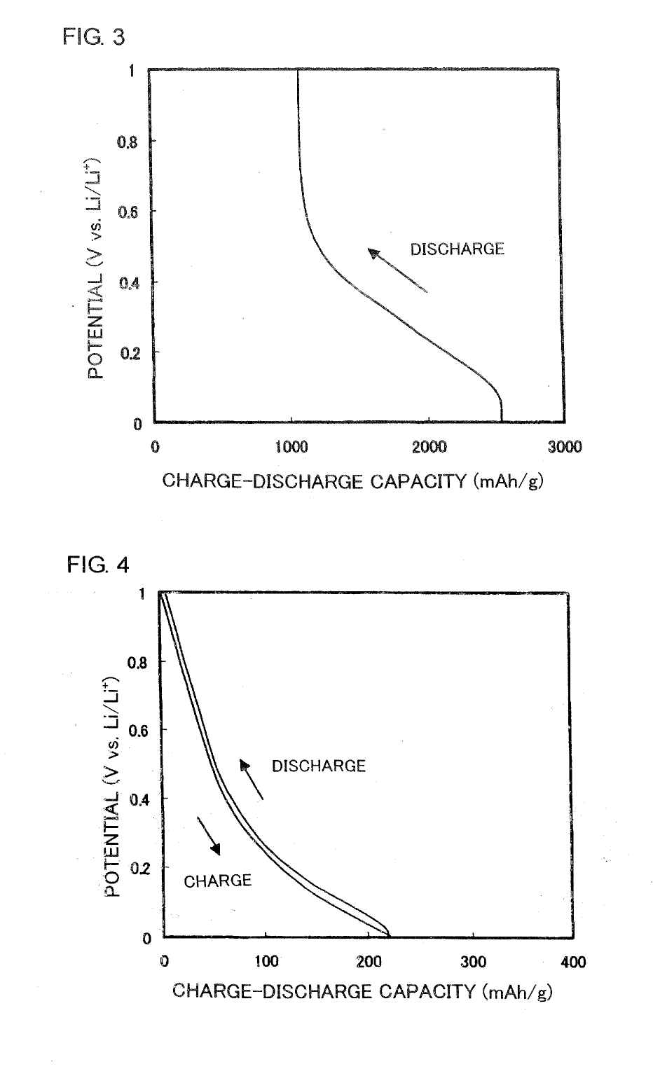

As shown in FIG. 1, a separator 3 made of a polyolefin micro-porous membrane was interposed between the above positive electrode 1 and the above negative electrode 2 to form an assembly, and the assembly was inserted into a container 4 made of a laminated film, and the above-mentioned electrolyte was filled in the container 4 to impregnate the positive electrode 1, the negative electrode 2, and the separator 3 with the electrolyte. A negative electrode terminal 2b is connected to a negative electrode collector 2a, and a positive electrode terminal 1b is connected to a positive electrode collector 1a. An opening of the container 4 was fused by heating to seal so that the negative electrode terminal 2b and the positive electrode terminal 1b are projected out of the container 4.

The cell thus produced was left stood for at least 3 days before measurement.

### Example 1

The porous Li₃SiO powder was used as an anode active material to prepare the above-mentioned cell.

### Example 2

Highly crystalline graphite exhibiting charge and discharge behavior shown in FIG. 2 and porous LiₓSiO (x=2, 2.1, 2.5, 3, 4) powder were mixed in a mortar so as to become a ratio of 1:1 by weight, and the resulting mixture was used as an anode active material.

### Example 3

Low crystalline graphitizable carbon exhibiting charge and discharge behavior shown in FIG. 4 and porous LiₓSiO (x=2, 2.1, 2.5, 3, 4) powder were mixed in a mortar so as to become a ratio of 1:1 by weight, and the resulting mixture was used as an anode active material.

### Comparative Example 1

The above-mentioned comparative Li₃SiO powder was used as an anode active material to prepare the above-mentioned cell.

### Comparative Example 2

Highly crystalline graphite exhibiting the charge and discharge behavior shown in FIG. 2 and low crystalline graphitizable carbon exhibiting the charge and discharge behavior shown in FIG. 4 were used as an anode active material to produce the above cell. For the highly crystalline graphite and the low crystalline graphitizable carbon, those in which Li was doped, and those in which Li was not doped were respectively produced, and they were used as an anode active material. Doping of Li was performed by the same procedure as in containing of lithium described above. An amount of doping was about 100 mAh/g.

### [Evaluation of Characteristics of Cell.]

A discharge capacity at the time of charging a cell at a constant current of 0.5 mA up to 3.8 V and discharging at a constant current of 0.5 mA up to 2.0 V was set as an initial capacity. In addition, values of the initial capacity in Tables 1 to 5 are values converted assuming that a value of the initial capacity in Comparative Example 2 using the highly crystalline graphite, in which Li is not doped, as an anode active material is 100.

A charge-discharge cycle test was performed by charging at a constant current of 25 mA up to 3.8 V, discharging at a constant current of 25 mA up to 2.0 V, and considering a sequence of charging and discharging as one cycle. However, in the case of a cell not exhibiting capacity characteristics before reaching 2.0 V such as carbon materials in which Li was not doped, a minimum voltage at which capacity characteristics were shown was set as a voltage end. As cycle characteristics, a ratio of a discharge capacity after 1000 cycles to an initial discharge capacity was shown.

As load characteristics, a ratio of a discharge capacity at a discharge current of 25 mA to a discharge capacity at a discharge current of 0.5 mA was shown.

The measurements were all carried out at 25° C.

The results of Example 1 are shown in Table 1, the results of Example 2 are shown in Table 2, the results of Example 3 are shown in Table 3, the results of Comparative Example 1 are shown in Table 4, and the results of Comparative Example 2 are shown in Table 5.

TABLE 1

| | | | Load Characteristics |
|---|---|---|---|
| Negative | | Cycle | (50 C Capacity/ |
| Electrode | Initial | Characteristics | 1 C Capacity) |
| Active Material | Capacity | (%) | (%) |
| Porous Li₃SiO | 180 | 33 | 80 |

TABLE 2

| | | | Cycle | Load Characteristics |
|---|---|---|---|---|
| | x in Porous | Initial | Characteristics | (50 C Capacity/1 C Capacity) |
| Carbon Material | LiₓSiO | Capacity | (%) | (%) |
| Highly Crystalline | 2.0 | 90 | 33 | 65 |
| Graphite | | | | |
| Highly Crystalline | 2.1 | 120 | 50 | 70 |
| Graphite | | | | |
| Highly Crystalline | 2.5 | 155 | 60 | 73 |
| Graphite | | | | |
| Highly Crystalline | 3.0 | 158 | 61 | 71 |
| Graphite | | | | |
| Highly Crystalline | 4.0 | 160 | 63 | 72 |
| Graphite | | | | |

TABLE 3

| | | | Cycle | Load Characteristics |
|---|---|---|---|---|
| | x in Porous | Initial | Characteristics | (50 C Capacity/1 C Capacity) |
| Carbon Material | LiₓSiO | Capacity | (%) | (%) |
| Low Crystalline | 2.0 | 91 | 35 | 72 |
| Carbon | | | | |
| Low Crystalline | 2.1 | 170 | 85 | 93 |
| Carbon | | | | |
| Low Crystalline | 2.5 | 181 | 95 | 95 |
| Carbon | | | | |
| Low Crystalline | 3.0 | 182 | 95 | 95 |
| Carbon | | | | |
| Low Crystalline | 4.0 | 186 | 95 | 94 |
| Carbon | | | | |

TABLE 4

| | | | Load Characteristics |
|---|---|---|---|
| Negative | | Cycle | (50 C Capacity/ |
| Electrode | Initial | Characteristics | 1 C Capacity) |
| Active Material | Capacity | (%) | (%) |
| Li₃SiO | 179 | 38 | 53 |

TABLE 5

| Negative | | | Cycle | Load Characteristics |
|---|---|---|---|---|
| Electrode Active | | Initial | Characteristics | (50 C Capacity/1 C Capacity) |
| Material | Li Doped | Capacity | (%) | (%) |
| Highly Crystalline | Not | 100 | 53 | 30 |
| Graphite | Doped | | | |
| Low Crystalline | Not | 93 | 62 | 48 |
| Carbon | Doped | | | |
| Highly Crystalline | Doped | 188 | 50 | 29 |
| Graphite | | | | |
| Low Crystalline | Doped | 186 | 61 | 45 |
| Carbon | | | | |

As is apparent from comparison between the results shown in Table 1 and the results shown in Table 4, by employing porous Li₃SiO as an anode active material in accordance with the present invention, the load characteristics can be improved. As the reason for this, it is considered that since the electrolyte was sufficiently impregnated in the negative electrode, load characteristics were improved without having a shortage of ion quantity at high output.

As is apparent from the results shown in Table 2, by mixing porous LiₓSiO with the highly crystalline graphite, not only the load characteristics but also the cycle characteristics can be improved. It is considered that by mixing the highly crystalline graphite, the deterioration of the electrode was inhibited and thus the cycle characteristics were improved.

It is found from the results shown in Table 4 that the lithium content x is preferably in a range of 2.1 to 4.0, and more preferably in a range of 2.5 to 4.0.

It is found from the results shown in Table 3 that by mixing porous LiₓSiO with the low crystalline graphitizable carbon, the load characteristics and the cycle characteristics can be further improved. As the reason for this, it is considered that more Li is doped with the low crystalline graphitizable carbon. It is found that the lithium content x is preferably in a range of 2.1 to 4.0, and more preferably in a range of 2.5 to 4.0.

In the present invention, when a mixture of the porous LiₓSiO and the carbon material is used, it is considered that Li in LiₓSiO is doped with the carbon material.

1. An energy storage device comprising a positive electrode composed of a polarizable electrode including activated carbon, a negative electrode including a material capable of inserting and extracting lithium ions as an anode active material, and a nonaqueous electrolyte,
wherein lithium-containing porous metal oxide is included as the anode active material.

2. The energy storage device according to claim 1, wherein a BET specific surface area of the lithium-containing porous metal oxide is 50 m²/g or more.

3. The energy storage device according to claim 1, wherein a mixture of the lithium-containing porous metal oxide and a carbon material capable of inserting and extracting lithium ions is used as the anode active material.

4. The energy storage device according to claim 3, wherein the carbon material is low crystalline graphitizable carbon, or non-graphitizable carbon.

5. The energy storage device according to claim 1, wherein the lithium-containing porous metal oxide is expressed by LiₓSiO.

6. The energy storage device according to claim 5, wherein a lithium content x in the LiₓSiO is 2.1 to 4.0.

7. The energy storage device according to claim 2, wherein a mixture of the lithium-containing porous metal oxide and a carbon material capable of inserting and extracting lithium ions is used as the anode active material.

8. The energy storage device according to claim 7, wherein the carbon material is low crystalline graphitizable carbon, or non-graphitizable carbon.

9. The energy storage device according to claim 2, wherein the lithium-containing porous metal oxide is expressed by LiₓSiO.

10. The energy storage device according to claim 9, wherein a lithium content x in the LiₓSiO is 2.1 to 4.0.

11. The energy storage device according to claim 3, wherein the lithium-containing porous metal oxide is expressed by LiₓSiO.

12. The energy storage device according to claim 11, wherein a lithium content x in the LiₓSiO is 2.1 to 4.0.

13. The energy storage device according to claim 4, wherein the lithium-containing porous metal oxide is expressed by LiₓSiO.

14. The energy storage device according to claim 13, wherein a lithium content x in the LiₓSiO is 2.1 to 4.0.
